(19) United States
(12) Patent Application Publication
(10) Pub. No.: US 2007/0223042 A1
(43) Pub. Date: Sep. 27, 2007

(54) METHOD AND APPARATUS FOR ADJUSTING GRAY LEVEL DISTRIBUTION OF AN IMAGE DISPLAYED ON LIQUID CRYSTAL DISPLAY DEVICE

(75) Inventors: Ming-Chia SHIH, Tainan County (TW); Fu-Chi YANG, Tainan County (TW); Ying-Hao HSU, Tainan County (TW)

Correspondence Address: LOWE HAUPTMAN BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 11/688,634

(22) Filed: Mar. 20, 2007

(30) Foreign Application Priority Data
Mar. 23, 2006 (TW) 95110050

(51) Int. Cl. H04N 1/40

(52) U.S. Cl. 358/3.01

(57) ABSTRACT

A method for adjusting the gray level distribution of an image displayed on a liquid crystal display includes the steps of determining a first relatively large gray level, a first maximum gray level, and a gain based on a gray level distribution of an image, and adjusting gray levels of pixels of the image using the gain in order to enhance image contrast and thereby improve quality of the image.

### RELATED APPLICATIONS

The present application is based on, and claims priority from, TW Application Number 95110050 filed Mar. 23, 2006, the disclosure of which is hereby incorporated by reference herein in its entirety.

### BACKGROUND OF THE PRESENT INVENTION

1. Field of Invention

The present invention relates to a method and an apparatus for adjusting the gray level distribution of an image, and more particularly to a method and an apparatus for adjusting the gray level distribution of an image displayed on a liquid crystal display (LCD) device.

2. Description of the Related Art

The screen on a liquid crystal display panel (LCD panel) is composed of numerous arrays of pixels. Luminance of each pixel depends on luminance of the backlight module of the liquid crystal display (LCD) and gray levels attributed to the pixels of the LCD panel. Among conventional techniques for driving a LCD, the most widely used one involves keeping the luminance of the backlight module at a constant level and changing the orientation direction of liquid crystal molecules of each pixel when different electric fields are applied across pixels. The liquid crystal molecules of the pixels will rotate the polarization direction of light when different electric fields are applied across the pixels. Thus, the transmittance of the liquid crystal cell in accordance with the orientation directions of the liquid crystal cells could be changed in order to display the polarized light of the successive frames on the liquid crystal panel of the liquid crystal display device.

A typical display device displays an image using a fixed range of luminance levels. For many displays, the luminance range has 256 levels that are uniformly spaced from 0 to 255. Image code values are generally assigned to match these levels directly. Thus, according to the prior art, the LCD panel has a plurality of pixels, which are denoted by gray levels, namely 0, 1, 2, . . . L. For example, in an 8-bit image displaying system, the gray value 0 denotes the minimum luminance level and the gray level L denotes the maximum luminance level when L=255.

As disclosed in the prior art, in order to clearly display lower luminance levels of the image on the LCD panel in a power-saving manner, a conventional LCD driving method comprises the steps of: detecting the largest gray level Xₘₐₓ of the pixels, obtaining a gain value GAIN by the largest gray level Xₘₐₓ of the pixels and the upper-limited gray level Xₗᵢₘᵢₜ displayable by the LCD panel, wherein GAIN=Xₗᵢₘᵢₜ/Xₘₐₓ, adjusting gray levels of the LCD panel such that the gray levels Xₐₘ of the pixels are mapped to the gray levels X_{bm}, wherein X_{bm}=GAIN*Xₐₘ and both Xₐₘ and X_{bm} denote gray levels of every two pixels of the LCD panel with m=0, 1, 2, . . . n. The LCD driving method further comprises the steps of adjusting an output luminance BLU′ of a backlight unit of the LCD panel such that the adjusted output luminance BLU′ equals the initial output luminance BLU*(1/GAIN)^{γ}, wherein γ denotes the gamma value commonly applicable to LCD panels. Although linear adjustment of the largest gray level Xₘₐₓ allows the adjusted largest gray level Xₘₐₓ to become equal to the largest gray level Xₗᵢₘᵢₜ displayable by the LCD panel, the largest gray level Xₘₐₓ is affected by noise or an unstable image data signal. In the aforesaid situation, the LCD panel is susceptible to an increase of screen-dependent variance and instability of the mapped gray level X_{bm} and the adjusted output luminance BLU′ of the backlight unit of the LCD, thus resulting in screen shimmer and screen flicker.

### SUMMARY OF THE PRESENT INVENTION

The present invention is directed to providing a method and an apparatus for adjusting gray levels of pixels of an image displayed on a liquid crystal display (LCD) which determines a first relatively large gray level, a first maximum gray level, and a gain based on a gray level distribution of an image and adjusts gray levels of pixels of the image using the gain in order to enhance image contrast, improve quality of the image, and reduce power consumption.

The present invention is also directed to providing a method and an apparatus for adjusting image gray levels which determines a first relatively large gray level, a first maximum gray level, and a gain based on a gray level distribution of an image and adjusts gray levels of pixels of the image using the gain in order to enhance image contrast, improve quality of the image, and reduce power consumption.

The present invention is further directed to providing a method and an apparatus for adjusting gray levels of pixels of an image displayed on a liquid crystal display which determines a first relatively large gray level and a second relatively large gray level based on a gray level distribution of an image, determines the first relatively large gray level of the image based on the absolute value of the difference between the second relatively large gray level of the image and the second relatively large gray level of the preceding image, sets a first maximum gray level and a gain based on the first relatively large gray level of the image, and adjusts gray levels of pixels of the image using the gain in order to enhance image contrast, improve quality of the image, and reduce power consumption.

The present invention yet further directed to providing a method and an apparatus for adjusting image gray levels which determines a first relatively large gray level and a second relatively large gray level based on a gray level distribution of an image, determines the first relatively large gray level of the image based on the absolute value of the difference between the second relatively large gray level of the image and the second relatively large gray level of the preceding image, sets a first maximum gray level and a gain based on the first relatively large gray level of the image, and adjusts gray levels of pixels of the image using the gain in order to enhance image contrast, improve quality of the image, and reduce power consumption.

Accordingly, in order to accomplish the one or some or all of the above, the present invention provides a method for adjusting gray levels of pixels of an image displayed on a liquid crystal display, comprising the steps of: receiving said image; creating a gray level distribution based on the image; determining a first relatively large gray level based on the gray level distribution; setting a first maximum gray level based on the first relatively large gray level; obtaining a gain based on the first relatively large gray level and the first maximum gray level; and adjusting gray levels of pixels of the image the gain.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 shows a gray level distribution graph for the first embodiment of the present invention.

FIG. 2 shows a gray level distribution graph for the second embodiment of the present invention.

### DESCRIPTION OF THE PREFERRED EMBODIMENT

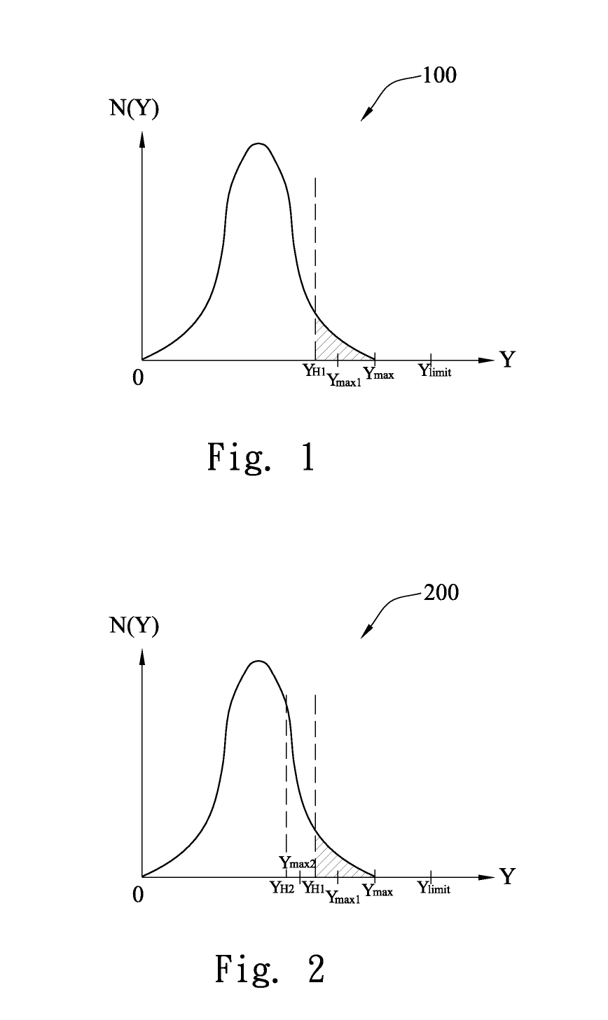

Referring to FIG. 1, a gray level distribution graph according to a first preferred embodiment of the present invention is illustrated. In the present invention, the method for adjusting gray levels performs the statistical analysis of gray levels of pixels of an image upon receipt of the image by a liquid crystal display (LCD) and generates a gray level distribution (graph) 100, wherein the horizontal axis Y shows the gray levels and the vertical axis N (Y) shows the number N of the pixels of the image having the gray level Y, with the largest gray level of the pixels of the image denoted by Yₘₐₓ (largest gray level) and the upper-limited gray level displayable by the liquid crystal display panel (LCD panel) denoted by Yₗᵢₘᵢₜ (for example, the upper-limited gray level Yₘₐₓ of an 8-bit image displaying system is 255). The method for adjusting gray levels of pixels of an image further comprises the steps of determining a first relatively large gray level Yₘₐₓ₁ based on the gray level distribution (graph) 100. The first relatively large gray level Yₘₐₓ₁ is determined by the product of the summation of the total number of pixels of the image multiplied by a first predetermined percentage C1 (1%, for example) with every pixel having a gray level greater than or equal to the first relatively large gray level Yₘₐₓ₁ and the summation of the total number of pixels, as defined by the equation below:

$${\sum }_{Y = {Y}_{max 1}}^{Y = 255} N ( Y ) = {\sum }_{Y = 0}^{Y = 255} N ( Y ) * C 1 ( 1 \% , for example ) \qquad ( 1 )$$

The first relatively large gray level Yₘₐₓ₁ is determined by equation (1).

Moreover, a first maximum gray level Yₘₐₓₚ₁ is set according to the first relatively large gray level Yₘₐₓ₁ and the first maximum gray level Yₘₐₓₚ₁ is larger than the first relatively large gray level Yₘₐₓ₁. Hence, a gain (GAIN) is obtained by means of the first maximum gray level Yₘₐₓₚ₁ and the first relatively large gray level Yₘₐₓ₁, within the gain (Gain) equals to Yₘₐₓₚ₁/Yₘₐₓ₁ and the first relatively large gray level Yₘₐₓ₁ is less than or equal to the largest gray level of the image Yₘₐₓ.

The method for adjusting gray levels in the present invention further comprises the steps of adjusting gray levels of pixels of the image such that the gray levels Xₐₘ of the pixels are mapped to the gray levels X_{bm}, wherein X_{bm} equals GAIN*Xₐₘ and both Xₐₘ and X_{bm} denote gray levels of the pixels of the LCD panel with m=0, 1, 2, . . . n. The method for adjusting gray levels in the present invention further comprises the steps of adjusting output luminance BLU′ of a backlight unit of the LCD such that the adjusted output luminance BLU′ equals the initial output luminance BLU*(1/GAIN)^{γ}, wherein γ denotes the gamma value commonly applicable to LCDs.

Referring to FIG. 2, a gray level distribution graph according to a second preferred embodiment of the present invention is illustrated. The method for adjusting gray levels performs a statistical analysis of gray levels of pixels of an image upon receipt of the image by a LCD and generates a gray level distribution (graph) 200, wherein the horizontal axis Y shows the gray levels and the vertical axis N (Y) shows the number N of the pixels of the image having the gray level Y, with the largest gray level of the pixels of the image denoted by Yₘₐₓ (largest gray level) and the upper-limited gray level displayable by the LCD panel by Yₗᵢₘᵢₜ (for example, the gray scale limit Yₘₐₓ of an 8-bit image displaying system is 255). The method for adjusting gray levels in the present invention further comprises the steps of determining a first relatively large gray level Yₘₐₓ₁ based on the gray level distribution (graph) 200. The first relatively large gray level Yₘₐₓ₁ is determined by the product of the summation of the total number of pixels of the image multiplied by a first predetermined percentage C1 (1%, for example) with every pixel having a gray level greater than or equal to the first relatively large gray level Yₘₐₓ₁ and the summation of the total number of pixels of the image, as defined by the equation below:

$${\sum }_{Y = {Y}_{max 1}}^{Y = 255} N ( Y ) = {\sum }_{Y = 0}^{Y = 255} N ( Y ) * C 1 \qquad ( 2 )$$

The method for adjusting gray levels in the present invention further comprises the steps of determining a second relatively large gray level Yₘₐₓ₂ based on the gray level distribution (graph) 200, wherein the second relatively large gray level Yₘₐₓ₂ is determined by the product of the summation of the total number of pixels of the image multiplied by a second predetermined percentage C2 (5%, for example) with every pixel having a gray level greater than or equal to the second relatively large gray level Yₘₐₓ₂, as defined by the equation below:

$${\sum }_{Y = {Y}_{max 2}}^{Y = 255} N ( Y ) = {\sum }_{Y = 0}^{Y = 255} N ( Y ) * C 2 \qquad ( 3 )$$

The second predetermined percentage C2 is greater than the first predetermined percentage C1. A first relatively large gray level of the image and a first relatively large gray level of the preceding image are denoted by Yₘₐₓ₁(n) and Yₘₐₓ₁(n−1) respectively. A second relatively large gray level of the image and a second relatively large gray level of the preceding image are denoted by Yₘₐₓ₂(n) and Yₘₐₓ₂(n−1) respectively. The absolute value of the difference between the first relatively large gray level Yₘₐₓ₁(n) of the image and the first relatively large gray level Yₘₐₓ₁(n−1) of the preceding image is calculated by the equation (4) as follows:
ΔYₘₐₓ₁(n)=|Yₘₐₓ₁(n)−Yₘₐₓ₁(n−1)| (4)

The absolute value of the difference between the second relatively large gray level Yₘₐₓ₂ (n) of the image and the second relatively large gray level Yₘₐₓ₂(n−1) of the preceding image is calculated by the equation (5) as follows:
ΔYₘₐₓ₂(n)=|Yₘₐₓ₂(n)−Yₘₐₓ₂(n−1)| (5)

Upon determination that the absolute value ΔYₘₐₓ₂(n) of the difference between the second relatively large gray level Yₘₐₓ₂(n) of the image and the second relatively large gray level Yₘₐₓ₂(n−1) of the preceding image is 0, the relation between the first relatively large gray level Yₘₐₓ₁(n) of the image and the first relatively large gray level Yₘₐₓ₁(n−1) of the preceding image is defined by the equation as follows:
Yₘₐₓ₁(n)=Yₘₐₓ₁(n−1)±A*ΔYₘₐₓ₁(n), wherein A is typically set to 0.

Upon determination that the absolute value ΔYₘₐₓ₂(n) of the difference between the second relatively large gray level Yₘₐₓ₂(n) of the image and the second relatively large gray level Yₘₐₓ₂(n−1) of the preceding image is 1, the relation between the first relatively large gray level Yₘₐₓ₁(n) of the image and the first relatively large gray level Yₘₐₓ₁(n−1) of the preceding image is defined by the equation as follows:

Yₘₐₓ₁(n)=Yₘₐₓ₁(n−1)±B*ΔYₘₐₓ₁(n), wherein the sign used in the equation depends on the sign of the difference between the first relatively large gray level of the image and the first relatively large gray level of the preceding image.

Upon determination that the absolute value ΔYₘₐₓ₂(n) of the difference between the second relatively large gray level Yₘₐₓ₂(n) of the image and the second relatively large gray level Yₘₐₓ₂(n−1) of the preceding image is 2, the relation between the first relatively large gray level Yₘₐₓ₁(n) of the image and the first relatively large gray level Yₘₐₓ₁(n−1) of the preceding image is defined by the equation as follows:

Yₘₐₓ₁(n)=Yₘₐₓ₁(n−1)±C*ΔYₘₐₓ₁(n), wherein the sign used in the equation depends on the sign of the difference between the first relatively large gray level of the image and the first relatively large gray level of the preceding image.

Upon determination that the absolute value ΔYₘₐₓ₂(n) of the difference between the second relatively large gray level Yₘₐₓ₂(n) of the image and the second relatively large gray level Yₘₐₓ₂(n−1) of the preceding image is 3, the relation between the first relatively large gray level Yₘₐₓ₁(n) of the image and the first relatively large gray level Yₘₐₓ₁(n−1) of the preceding image is defined by the equation as follows:

Yₘₐₓ₁(n)=Yₘₐₓ₁(n−1)±D*ΔYₘₐₓ₁(n), wherein the sign used in the equation depends on the sign of the difference between the first relatively large gray level of the image and the first relatively large gray level of the preceding image.

Upon determination that the absolute value ΔYₘₐₓ₂(n) of the difference between the second relatively large gray level Yₘₐₓ₂(n) of the image and the second relatively large gray level Yₘₐₓ₂(n−1) of the preceding image is 4, relation between the first relatively large gray level Yₘₐₓ₁(n) of the image and the first relatively large gray level Yₘₐₓ₁(n−1) of the preceding image is defined by the equation as follows:

Yₘₐₓ₁(n)=Yₘₐₓ₁(n−1)±E*ΔYₘₐₓ₁(n), wherein the sign used in the equation depends on the sign of the difference between the first relatively large gray level of the image and the first relatively large gray level of the preceding image.

In the five aforesaid equations, A≧B≧C≧D≧E≧1

The method for adjusting gray levels in the present invention further comprises the steps of setting a first maximum gray level Yₘₐₓₚ₁ based on the first relatively large gray level Yₘₐₓ₁(n), wherein the first maximum gray level Yₘₐₓₚ₁ is greater than the first relatively large gray level Yₘₐₓ₁(n), and then obtaining a gain GAIN based on the first relatively large gray level Yₘₐₓ₁(n) and the first maximum gray level Yₘₐₓₚ₁, wherein GAIN=Yₘₐₓₚ₁/Yₘₐₓ₁(n). The first relatively large gray level Yₘₐₓ₁(n) is less than or equal to the largest gray level Yₘₐₓ of the image.

The method for adjusting gray levels as disclosed in the present invention further comprises the steps of adjusting gray levels of pixels of the image such that the gray levels Xₐₘ of the pixels are mapped to the gray levels X_{bm}, wherein X_{bm} equals GAIN*Xₐₘ and both Xₐₘ and X_{bm} denote gray levels of the pixels of the LCD panel with m=0, 1, 2, . . . n. The method for adjusting gray levels further comprises the steps of adjusting output luminance BLU′ of a backlight unit of the LCD such that the adjusted output luminance BLU′ equals the initial output luminance BLU*(1/Gain)^{γ}, wherein γ denotes the gamma value commonly applicable to LCDs.

Alternatively, gray levels of the pixels of the image can be adjusted in the way as follows.

First, the relatively large gray levels of four images of the first or second embodiment are obtained. Assuming that the first relatively large gray level of the nth image is denoted by Yₘₐₓ₁(n), the first relatively large gray level of the (n−1)th image by Yₘₐₓ₁(n−1), the first relatively large gray level of the (n−2)th image by Yₘₐₓ₁(n−2), and the first relatively large gray level of the (n−3)th image by Yₘₐₓ₁(n−3), the first relatively large gray levels are defined by the equation (6) as follows:
Y′ₘₐₓ₁(n)=A1*Yₘₐₓ₁(n)+A2*Yₘₐₓ₁(n−1)+A3*Yₘₐₓ₁(n−2)+A4*Yₘₐₓ₁(n−3) (6)

wherein A1+A2+A3+A4=1

The method for adjusting gray levels as disclosed in the present invention further comprises the steps of setting a first maximum gray level Y′_{max P1} based on the first relatively large gray level Y′ₘₐₓ₁(n), wherein the first maximum gray level Y′_{max P1} is greater than the first relatively large gray level Y′ₘₐₓ₁(n), and then obtaining a gain GAIN based on the first relatively large gray level Y′ₘₐₓ₁(n) and the first maximum gray level Y′_{max P1}, wherein GAIN=Y′_{max P1}/Y′ₘₐₓ₁(n). The first relatively large gray level Y′ₘₐₓ₁(n) is less than or equal to the largest gray level Yₘₐₓ of the image.

The method for adjusting gray levels in the present invention further comprises the steps of adjusting gray levels of pixels of the image such that the gray level Xₐₘ of the pixels are mapped to the gray levels X_{bm}, wherein X_{bm} equals GAIN*Xₐₘ and both Xₐₘ and X_{bm} denote gray levels of the pixels of the LCD panel with m=0, 1, 2, . . . n. The method for adjusting gray levels further comprises the steps of adjusting output luminance BLU′ of a backlight unit of the LCD such that the adjusted output luminance BLU′ equals the initial output luminance BLU*(1/GAIN)^{γ}, wherein γ denotes the gamma value commonly applicable to LCDs.

Although the aforesaid preferred embodiments recite obtaining first relatively large gray levels of four images, the scope of claims of the present invention is not limited to the aforesaid embodiments.

To apply the aforesaid method, the present invention further discloses an apparatus for adjusting gray levels of a liquid crystal display, comprising: an image detection unit for receiving an image, generating a gray level distribution based on the image, determining a first relatively large gray level based on the gray level distribution, setting a first maximum gray level based on the first relatively large gray level, and obtaining a gain based on the first relatively large gray level and the first maximum gray level and an image adjustment unit for adjusting gray levels of pixels of the image using the gain. With the apparatus, the image quality of a LCD is improved by reduction of screen shimmer and screen flicker which might otherwise arise because of an increase of screen-dependent variance and instability of the mapped gray level X_{bm} and the adjusted output luminance BLU′ of the backlight unit of the LCD in the presence of noise or an unstable image data signal.

To sum up, the present invention provides a method and an apparatus for adjusting the gray level distribution of an image displayed on a liquid crystal display (LCD) device to improve the image quality of a LCD by reducing screen shimmer and screen flicker which might otherwise arise because of an increase of screen-dependent variance and instability of the mapped gray level X_{bm} and the adjusted output luminance BLU′ of the backlight unit of the LCD in the presence of noise or an unstable image data signal.

One skilled in the art will understand that the embodiment of the present invention as shown in the drawings and described above is exemplary only and not intended to be limited thereby.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for adjusting gray levels of pixels of an image displayed on a liquid crystal display, comprising the steps of:
receiving said image;
generating a gray level distribution of said image;
determining a first relatively large gray level based on said gray level distribution;
setting a first maximum gray level based on said first relatively large gray level;
obtaining a gain based on said first relatively large gray level and said first maximum gray level; and
adjusting gray levels of pixels of said image using said gain.

2. The method for adjusting gray levels, as recited in claim 1, wherein said first relatively large gray level is determined by the product of a summation of the total number of pixels of said image multiplied by a first predetermined percentage with every pixel having a gray level greater than or equal to said first relatively large gray level and said summation of the total number of pixels.

3. The method for adjusting gray levels, as recited in claim 1, wherein said first relatively large gray level is less than said first maximum gray level.

4. The method for adjusting gray levels, as recited in claim 1, wherein said gain is obtained by dividing said first maximum gray level by said first relatively large gray level.

5. The method of adjusting gray levels, as recited in claim 1, wherein said first relatively large gray level is smaller than or equal to the largest gray level of said image.

6. A device for adjusting gray levels of pixels of an image displayed on a liquid crystal display, comprising:
an image detection unit for receiving said image, generating a gray level distribution based on said image, determining a first relatively large gray level based on said gray level distribution, setting a first maximum gray level based on said first relatively large gray level, and obtaining a gain based on said first relatively large gray level and said first maximum gray level; and
an image adjustment unit for adjusting gray levels of pixels of said image using said gain.

7. The device for adjusting gray levels of a liquid crystal display, as recited in claim 6, wherein said first relatively large gray level is determined by the product of a summation of the total number of pixels of said image multiplied by a first predetermined percentage with every pixel having a gray level greater than or equal to said first relatively large gray level and said summation of the total number of pixels.

8. The device for adjusting gray levels, as recited in claim 6, wherein said first relatively large gray level is less than said first maximum gray level.

9. The device for adjusting gray levels, as recited in claim 6, wherein said gain is obtained by dividing said first maximum gray level by said first relatively large gray level.

10. The device for adjusting gray levels, as recited in claim 6, wherein said first relatively large gray level is small than or equal to the largest gray level of said image.

11. A method for adjusting gray levels of pixels displayed on a liquid crystal display, comprising the steps of:
receiving an image and a preceding image;
generating a gray level distribution based on said image and said preceding image;
determining a first relatively large gray level and a second relatively large gray level of said image and said preceding image based on said gray level distribution for said image and said preceding image;
determining said first relatively large gray level of said image based on the absolute value of the difference between said second relatively large gray level of said image and said second relatively large gray level of said preceding image;
setting a first maximum gray level based on said first relatively large gray level of said image;
obtaining a gain based on said first relatively large gray level of said image and said first maximum gray level; and
adjusting gray levels of pixels of said image using said gain.

12. The method for adjusting gray levels, as recited in claim 11, wherein said first relatively large gray level is determined by the product of a summation of the total number of pixels of said image multiplied by a first predetermined percentage with every pixel having a gray level greater than or equal to said first relatively large gray level and said summation of the total number of pixels.

13. The method of adjusting gray levels, as recited in claim 11, wherein said second relatively large gray level is determined by the product of a summation of the total number of pixels of said image multiplied by a second predetermined percentage with every pixel having a gray level greater than or equal to said second relatively large gray level and said summation of the total number of pixels.

14. The method of adjusting gray levels, as recited in claim 11, wherein said absolute value of the difference between said second relatively large gray level of said image and said second relatively large gray level of said preceding image is zero, the relation between said first relatively large gray level of said image and said first relatively large gray level of said preceding image by the equation as follows: Yₘₐₓ₁(n)=Yₘₐₓ₁(n−1)±A*ΔYₘₐₓ₁ (n), where ΔYₘₐₓ₁(n) denotes the difference between said first relatively large gray level of said image Yₘₐₓ₁(n) and said first relatively large gray level of said preceding image Yₘₐₓ₁(n−1).

15. The method of adjusting gray levels, as recited in claim 11, wherein said absolute value of the difference between said second relatively large gray level of said image and said second relatively large gray level of said preceding image is not zero, the relation between said first relatively large gray level of said image and said first relatively large gray level of said preceding image by the equation as follows: Yₘₐₓ₁(n−1)±A*ΔYₘₐₓ₁(n), where A is less than 1, and ΔYₘₐₓ₁(n) denotes the difference between said first relatively large gray level of said image Yₘₐₓ₁(n) and said first relatively large gray level of said preceding image Yₘₐₓ₁(n−1).

16. The method of adjusting gray levels of claim 11, wherein said first relatively large gray level is less than said first maximum gray level.

17. The method of adjusting gray levels of claim 11, wherein said gain is obtained by dividing said first maximum gray level by said first relatively large gray level.

18. The method of adjusting gray levels of claim 11, wherein said first relatively large gray level is not greater than the largest gray level of said image.
